(19) United States
(12) Patent Application Publication
(10) Pub. No.: US 2017/0011141 A1
(43) Pub. Date: Jan. 12, 2017

(54) User-friendly system of sequencing using combined limited temporal logical and numerical constraints, also extendable to probabilistic constraints, for complex sequencing optimization of time intervals over time period, also applicable to general modeling and catastrophic even modeling

(71) Applicant: OLIVER DEHOUSSE, (US)

(72) Inventor: Olivier Dehousse, New York City, NY (US)

(73) Assignee: OLIVIER DEHOUSSE

(21) Appl. No.: 14/545,941

(22) Filed: Jul. 10, 2015

(51) Int. Cl. G06F 17/50; G06N 5/04; G06F 17/18

(52) U.S. Cl. CPC G06F 17/5009; G06F 17/18; G06N 5/045

(57) ABSTRACT

Among various approaches to intervals sequencing modeling and optimizations over time (traditionally numerical and logical optimization are separated fields), such as numerical optimization which advantages are to offer a quantified approach to problem solving almost without limits, but within range of specific applications, or optimization under logical constraints, we present here an original approach, which goal is to combine in a structured and easier to use way, logical and numerical constraints, into one original method, that will accumulate the benefits of both approaches to intervals sequencing problem solving, or even more, for the purpose of sequencing optimization over time, and modeling (including catastrophic events modeling). Our method also aims to support manager and systems choices in their respective search for problem solving of intervals optimization sequencing and is capable to combine an approach of numerical modeling and higher degree of expressiveness, making it easy to use.

### CROSS-REFERENCE

Ser. Nos. 13,068/193 and 14/120,731 (same owner)

### FEDERALLY SPONSORED RESEARCH

not applicable

### SEQUENCE LISTING OR PROGRAM

see 3 tables

### BACKGROUND

We present an original method, which we essentially base on our own patent (Ser. Nos. 13,068/193 and 14/120,731) and revised concepts of already existing temporal systems using artificial logic, (similar to f.i. the one developed by the J. F. Allen), where we combine abstract restrained temporal logical constraints with numerical constraints, which we designed and developed to respond to natural expectations of a true artificial intelligence system (in terms of system structure, mathematical properties, and user-friendliness such as a knowledge base, an inference engine or method, and verifying mathematical adequation and completeness properties), keeping in mind the important of knowledge base expressiveness.

We strongly believe that, in order to respond to the expectations highlighted above, our system of logical constraints have also to respond to the properties of basic mathematical set operation (e.g. symmetry, reflexivity, transitivity, etc. . . . ). In order to achieve such goal, we limit ourselves to a unique temporal logic constraint which we call “taking place before” or “<”. Because of the numerical constraints introduced, we believe it is enough to limit ourselves to one such constraint, even assuming considerations of expressiveness of the knowledge base. We will also refer to methods to introduce new constraints, and new intervals, on the basis of a maintained knowledge base. Our system is designed in such a way that our knowledge base is a true know base and can be consulted any time.

Our system is also meant to support managers and expert systems in their goals in finding solutions to problems of intervals (or also tasks) optimization sequencing (or also ordering) under unlimited constraints, verifying complex numerical and logical constraints. It is very conceivable that such system can be used real time also, providing real time optimization based on some type of inputs.

Furthermore, as mentioned above, in the various types of sequencing modeling and optimizations that we know (except for our own), we have seen that authors have traditionally kept separated numerical (or quantitative) optimization from logical optimization. The advantages of numerical optimization is that it offers a quantified approach to problem solving almost without limits and within a range of applications specific to a model, but these models are usually much more difficult to comprehend and the artifacts available to increase the expressivity in such numerical models are lacking, and making them more difficult to use. These models are typically limited to the highly specialized areas of mathematical optimization, which requires any users to be acquainted with each areas of knowledge.

Although logical systems do not generally offer any quantified considerations—in specific when considering complex sequencing or ordering problems—, they usually provide other advantages such as allowing for a more abstract way to describe a problem and offering solutions using a set of logical propositions; however, their resolutions is usually rather complex, in the sense that it typically requires complex algorithms.

Nevertheless, such systems also offer various modeling options, used to integrate the problem's constraints, that are typically easier to comprehend by offering a higher expressivity.

Our inference engine will not be based on a pure transitivity table, such as in the way traditional authors of system of temporal logic are presenting theirs. The limitations that we can see in using such transitivity table are that they won't work as we would like them to work. To further illustrate our view, if we consider the two sequences of intervals X₁, X₂ X₃ X₄ A B X₅ X₆ X₇ and A X₁ X₂ X₃ X₄ B X₅ X₅ X₆ respectively, and we modify the relations between A and B, adding “taking place after” to an existing “taking place before”, it is expected to see a wide range of changes on various intervals but different on each respective sequences, and by that, we show in essence that the outcome of any transitive operations using complex matrix of transitivity can't be planned until a possible solution is known and therefore is not reliable and can't be used at all.

We offer here an original approach, which goal is to combine these two views in providing one original method unifying the benefits of both views, and potentially even much more. In theory, any problem could probably be solved with each type of systems, either numerical or logical, but it can only be done at the price of a highly complex mathematical modeling to integrate all the specificities of a problem.

Conversely, the method presented here, in combining multiple orders of logical and numerical constraints (more information later), will offer many simplifications that will make the complexity of a problem easier to model. Furthermore, our approach also supports another important aspect; it is that our optimization method will be built in a rather straight forward and much easy to understand modeling, applicable for non-expert about numerical optimization systems.

To complete our model, a calculus of the likelihood of occurrence for future events will also be offered, where past events probability will be used in conjunction with the Bayes's theorem to model or optimize future events sequencing. For the purpose of simplicity, we include this characteristic as a part of what we call later numerical constraints, for which we assume that one of our system baseline will necessarily describe an event as present, past or future, and for which we will also add a probability matrix linking when possible events' probability of occurrences together.

Use of logical constraint in this model: we use only one type of logical constraint, which we will represent with the sign “<”, or before. As such, [a]<[b] will denote that interval [a] is taking place before interval [b].

In the case where we have both [a]<[b] and [b]<[a] as set of constraints in our system, we lose the logical information between these two intervals.

We will also be completing the expressiveness of our concept in collecting the multiple optimal solutions and in refining, if and when necessary, the numerical constraints.

### ADVANTAGES

Our method is unique, in the sense that it enhances every possible optimization system that we know off, usually with a very limited use, and provides the foundation for a tool to support management decisions for managers faced with decisions including solving present, part of future. In the case where our system is used as model for predictions, it could also include a likelihood (probability) of occurrence. (In the case of past events, such value could be derived from calculus or rules of thumb, and for future value it will be calculated in using a matrix of probability linking dependent events, based on the Bayes's probability logic.

Intervals relative values are typically variable which take their value directly from the baseline (e.g. day in the month at which an event will take place) or are functions which take their value from the baseline (e.g. a financial function using the yield curve as one of the baseline of our system).

Interval elasticity values are variables that will force when the option is possible for one or some intervals constraints to take place instead of another one (or the way around, for one interval constraint not to take place). It will use as a key metric a space value between two intervals (without being a logical constraints).

Finally, external functions are also part of our system. External functions will be any type of functions, applying to all or any subset of intervals and all or any subset of interval values (absolute value, first degree relative value and second degree relative value). They will need to be considered when calculating the numerical side of the optimized solution of our system.

(External functions in our system will apply to entire baseline or only to some parts of baseline separately and are set of functions that will need to be optimized).

The possibilities for external functions, as well as any other categories of interval variables, to be weighted (by user) with different value at different times, providing different optimized solutions, is also an inherent part of our system.

The resolution algorithm of our system will take place in two intricate different steps, those steps are: in a first time, evaluating all the logical solution of our system in using transitivity to infer new information, and in a second time using each of these different logical solutions to provide a specific set of numerical equation to optimize. The optimized solution will be the solution to our system (logical and numerical) that is optimal.

For instance, our system will be able to translate high level requirements—translating means here to model in logical and numerical constraints in our system—such as “the sequence of events needs to respond to rules such as selected types of event need to occur only 3 times consecutively in specific sequences, and that all selective type of event occurs in the first ¾ of all sequences of our interval sequencing problem”.

Our system will allow for some functions to be built and will offer pre-built in functions and logical constraints (for instance such as responding to the logic from the example below), for instance for a user to pre-select from a catalog.

To further illustrate our thought process, f.i. a typical function to represent the concept of elasticity can be a basic exponential function which value increases by the space of number of intervals between two designated intervals (strong elasticity) or just by the number or space between intervals between two designated intervals (weak elasticity). Some weights (as applying on functions as well as on intervals values and making some functions and interval values more important than others) should be modifiable at the specific requests of a user. As different weights are applied, different optimal solutions might be generated.

For ease of use considerations, for instance, it is not clear if the system should calculate in advance various solutions from various weights or if the system should calculate these solutions as they apply to the weights changes on the fly. As such, a combination of both will be offered.

Furthermore, our system and its resolution will allow for multiple systems (per the description from above) to be grouped into one system of systems and to be resolved (find a set of optimal solutions) for system of systems.

complex intervals sequencing or scheduling problems, or lay the ground for complex mathematical modeling, including modeling of catastrophic events. These intervals are the abstract representation of objects, which for example can be either time intervals, or tasks over specified time sequence.

### THE SUMMARY

In summary, the patent here describes a method of artificial intelligence to support decision making for managers or expert systems facing complex problems, in the area of intervals sequencing and modeling, that will be built combining logical and numerical (or qualitative and quantitative) constraints, and as such offers a unique value, for decision support, sequencing optimization and even modeling (including modeling of catastrophic events). Our method is also intended to apply to complex problems of scheduling, and can also be used as the core method of more specialized applications in the area of automated requests or even scheduling.

Our method can also be used for real time sequencing, assuming that it can use real time inputs.

An example of such an application for our method could be a complex project (or more generally a sequencing of tasks responding to complex parameters), where intervals are time intervals, or tasks, and where the sequencing of intervals representing work elements responding to many complex constraints (of various logical and numerical orders).

This problem will also require that the sequencing of all tasks is optimized in a way responding to complex situation, which otherwise would require complex quantitative mathematical modeling research.

Our system will use one logical constraint “taking place before” or “<” to describe the respective positioning of intervals among themselves. While making the choice for this constraint, it is also important to notice that such choice of embedding temporal logical constraints will make the search for an optimal solution in using our method a problem that is of type NP-Hard (and will require the generation and handling of f(x)=fact(x) complexity or higher where x is the number of intervals considered.

We also enhance the expressivity of our logical constraints in using a concept called “elasticity”, and which will involved a specific quantitative aspect in the resolution of the interpretation of our logical constraint. This concept of “elasticity” between constraints will enable to dictate precedence rules among all the logical constraints, when there is a choice, in making some logical constraints on specific intervals more likely to be part (or not to be part) of a sequence of intervals solution than not. As such, we further increase the expressivity of the logical constraint with embedding an original method using these numerical constraints.

As we plan to leave it up to any users to decide where to use logical constraints, it is also important to note that there is a trade off to make with the building of this part of our system; less logical constraints can increase the complexity of the computation of the algorithm.

### EXPLANATORY TABLES

Table 1: Intervals value: this listing is showing all components of intervals properties, and their respective hierarchy that will need to be considered at the time of the resolution.

Table 2: Example 1: this listing is showing a somewhat realistic model where all qualitative and quantitative values apply to real life scenario in the area of project management and optimization of interval sequencing.

Table 3: Example 2: this listing is showing a basic example of a system, including one set of logical constraints of our choice (responding to the properties that we have described earlier), some quantitative constraints and the system resolution.

### DETAILED DESCRIPTION (INCLUDING ALGORITHMIC ASPECTS FOR IMPLEMENTATION)

General Description

Our method uses the combination of two types of constraints to describe a system, a logical type and a numerical type, to describe and resolve complex problems of sequencing of intervals in time period.

Our system will use one logical constraint to describe the respective positioning of intervals among themselves, called “taking place before” or “<”.

We also introduce the concept of “elasticity”, and which will involve specific quantitative aspects in the solution finding among these logical constraints. Such constraints can be seen as between abstract constraints and numerical constraint, and offer additional expressiveness to the system knowledge base at these two levels.

(This concept of “elasticity”, bringing some specific intervals closer to each others, will enable to define precedence numerical rules in addition to the logical constraints, and when there is a choice, it will make some logical constraints on specific intervals more likely to be part (or not) of an optimized solution than others).

The numerical part of our system allows quantify different aspects of the intervals and their respective relationships.

In our system, an interval value can hold multiple numerical values (value converted into numerical value) on multiple levels or degrees, in addition to external functions typically used as function(s) to maximize.

One level is an absolute level (or order) value, which won't change based on the interval position in each solutions from our system, and which an interval will acquire based on its relative and absolute position in a solution, although their value of course will. Typically, such level is given by complex functions, which take values given by the baselines or which will depend on the baseline.

The next level is a first level or degree (or order) relative value, which gives a value that will change based on the position of the interval within our system. A second degree (or order) relative value is a value as the first degree relative value, although instead of use a fixe baseline to get its value, it will use a relative value between two intervals (This relative distance could be based on baseline—see below—or relative values between intervals first degree relative values). A third order (called elastic constraints)—which we can see as a direct application of the concept of second degree or level relative value—will apply to the logical constraints and allow elasticity to help to establish the precedence of some logical constraints (when they are used as part of an optimized solution) over others, so that they can be integrated into the research of numerical optimizations within our system. Finally, another aspect of the second part of our system is the existence of various baselines. Baselines are values given by functions, that refer to interval space (the space in which intervals will be positioned as part of the optimized solution), that are defined independently from the final intervals positions, but on which some interval values (interval relative value) will rely to estimate their own value (interval relative value will typically use a baseline value to get their value).

Interval absolute values are typically numbers (e.g. 100, 100,000, or ⅓). Such absolute value interval will embrace a concept of values to indicate if an interval is from the As part of such system of systems, external functions (per our description from above) can also operate on specific elements of the system of systems (which we can call “vertical” constraints, as opposed to the constraints from our system per our description from above).

It is also our intend, specifically to make our method even easier to used, to offer sets of preconfigured numerical functions, that can be applied to either baseline or even intervals properties. (One can easily think of a standard calendar for standard baseline related to time, and some more complex numerical functions—for example a heat diffusion equation—as the characteristics under which specific intervals—in this example we mean physical intervals—of our system will need to be sequenced to be optimized). Furthermore, for simplicity and ease of use considerations, our system is also meant to include standard numerical constraints, for instance (but not limited to) when it comes to elastic constraints.

Basic Algorithm Considerations Applicable to Logical Constraints:

Definition:
Int{ . . . }: consists of Int₁, Int₂, Int₃, Int₄, . . . Intₓ: a set of x intervals from our system LC{ . . . } is the collection of logical constraints, each of them qualifying the relative position of each intervals, and of the type: Intₜ“<” Int_{q}
And finally, let NC{ . . . } represent all the numerical constraints which need to be either verified or optimized, such as MAX(NC){ . . . } represent the set of optimal numerical solutions for our logical system, where all numerical constraints that need to be verified are also verified.

Generation of All Possible Interval Sequences

Then, the procedure to follow to calculate this optimal solution is as follow.
1) the algorithm calculates, in a rigorous matter, all possible sequence of intervals, keeping only the sequences verifying the LC{ . . . }, the collection of logical constraints. The outcome of this process is our system knowledge base.
   In further details, all possible sequences of intervals Int₁, Int₂, Int₃, Int₄, . . . Intₓ, which account for (X!) sequences, can be easily obtained recursively in adding one extra interval at the time from Int{ . . . } in each possible positions in each sequence included in the knowledge base, and each time in verifying that the new sequence obtained verifies LC{ . . . }.
      a) ADD Int₂→S1: Int₁ Int₂ and KEEP S1 if validate with LC{ . . . } S2: Int₂ Int_{1 and} KEEP S2 if validate with LC{ . . . }.
      b) ADD Int₃→S1: Int₃ Int₁ Int₂ S2: Int₃ Int₂ Int₁ S3: Int₁ Int₃ Int₂ . . . S6: Int₂ Int₁ Int₃ [symbol]
      c) ADD Intₓ→S1: . . .

The outcome KB{ . . . }, consisting of the collection of sequences S1 . . . Sm verifying

LC{ . . . } is the knowledge base of our system under logical constraints.

Defining the Entire Knowledge Base Under Logical Constraints

(see above).

Adding a Relation to a Knowledge Base

Adding a logical constraint to the collection LC{ . . . } will require to verify this new logical constraints against each sequence contained in the knowledge base. Specific case: if the symmetrical constraint is already included in the KB, then the system losses information about the two intervals. That is to say that the appropriate new sequences need to be recalculated. It can be done with iteratively following the next two steps (subtracting and then adding an interval to the KB). Such operation follows the same logic as Subtracting relations to a knowledge base

Subtracting a Relation to a Knowledge Base

There is obviously a high price to pay for such operation. We suggest to follow the following procedure: remove the logical constraint from LC{ . . . }, remove any sequences including the two intervals from KB{ . . . }, and follow the step required to add each of the interval to KB{ . . . } iteratively.

Subtracting an Interval to a Knowledge Base

This operation will require to remove the interval from Int{ . . . } and remove any of the logical constraints from LC{ . . . } which applies to the interval, and finally remove any sequences including this interval from KB{ . . . }

Adding an Interval to a Knowledge Base

This operation requires to add the interval to Int{ . . . }, and build all possible sequences including this new interval in KB{ . . . } in adding the new interval in every possible position for each sequence of KB. Here, there is no need to validate the new sequence obtained against LC{ . . . } because no new constraints concerning the new interval has been introduced yet.

Finding the Optimized Sequence(s) under Numerical Constraints.

NC{ . . . } represent all the numerical constraints which need to be either verified or optimized, such as MAX(NC){ . . . } represent the set of optimal numerical solutions for our logical system.

Let SOL{ . . . } be the subset of all sequences included in KB{. . . }, which satisfy the numerical conditions imposed by all numerical constraints NC{ . . . } and MAX(NC){ . . . } their respective optimized values.

### OPERATION

The process that we are introducing requires the user to know how many tasks or intervals the system needs to operate on. A user will also need to have established where a logical constraint between intervals or tasks needs to be introduced, which he should find easy to use, due to the extensive (almost infinite) expressiveness of our system. Furthermore, some of these logical constraints can also be qualified with our concept of elasticity. Finally, quantitative value will be introduced in our system, to qualify some of the intervals or tasks properties in terms of a) absolute values and b) relative values (per our description before). The algorithm will find all optimal solutions, and will be easy to use. This algorithm can produce an optimized solution for many real life situations, which require an optimal ordering of tasks under real life constraints that can be translated into the logical and numerical constraints of our method.

### CONCLUSIONS

We present here an innovative method capable to model and resolve complex aspects of optimization of intervals sequencing (or tasks ordering problems) over time periods, that is applicable in the area of management support decision, for instance in complex projects, or even scheduling problems, where as such intervals would represent tasks to order, or even subtasks to order, as a solution that is optimal under a set of constraints, made of a combination of logical and numerical constraints and allowing for very high expressivity and relatively easy to use for non specialist in numerical optimization modeling. Such system can be considered a system of artificial intelligence and is also applicable to modeling, modeling for catastrophically events and real time optimization, assuming real time input into the system. Furthermore, for simplicity and ease of use considerations, our system is also meant to include standard numerical constraints, for instance (but not limited to) when it comes to elastic constraints.

TABLE 1

| | | |
|---|---|---|
| Sequence of calculation | Interval Logic | |
| | Logical constraints | Example: At the same time, Preceding, Following . . . |
| | Interval values | |
| | Level 1 | Baselines |
| | Level 2 | Absolute Values |
| | Level 3 | Relative value - First order |
| | Level 4 | Relative value - Second order |
| | Level 5 | Elasticity |
| | Level F1 | External function (Example: linear function solve, minimize or |
| | | maximize) |
| | Level F2 | External function - System of systems |

TABLE 2
Example - Problem 1

System uses 1 types of logical constraints:

Preceding

System intervals (which each represent a task li-mited to 10, but could be 100 s):
A1, A2, A3, A4, A5, A6, A7, A8, A9, A10
Given logical constraints in system (e.g. manager knows by experience that these are some constraints
that need to be respected, for instance the task A1 must

| | A1 precedes A2; A1 precedes A3; A1 precedes A4; A5 preceds A1; | |
|---|---|---|
| | A9 precedes A10; A7 preceds A3 | |
| Numerical Constraints: | Type Baseline: B1-B1 is 1 . . . 10 | |
| | Type Baseline: B2-B2 is 1 . . . 31 | |
| | Intervals properties (absolute value): Number of days that each | |
| | activity will take: A1: D(5); A2: D(7); A3: D(2); A4: D(1); A5: D(1); | |
| | A6: D(1); A7: D(1); A8: D(1); A9: D(1); A10: D(1) | |
| | Intervals properties (relative value): | |
| | 1. | Project is very risky, and PM needs to show progress in |
| | | spending as less as possible. This translates into a numerical |
| | | constraint of the type: Function Sum of estimated cost |
| | | needs to grow as slow as possible. So, the cost of the first |
| | | interval 1; interval 1 and 2; interval 1, 2 and 3; 1, 2, 3 and 4; . . . |
| | | until 7 need to be minimized for the optimal solution |
| | 2. | The complexity of the project makes it riskier if the number |
| | | of tasks handled in parallel is too high. We limit this |
| | | complexity in imposing a constraint of the type: Cost of |
| | | parallel tasks can't go above 5. If any solution offered has |
| | | parallel tasks going above 5, we do not consider the solution |
| | | as an optimal one. |

TABLE 3
Example: Problem 2 (easier)

1 types of logical constraints: preceding
Given logical constraints in the system (used as given value to our model):

A precedes B, C precedes B

Given numerical constraints in the system:

| | |
|---|---|
| Type Baseline: | 1, 2, 3 |
| Type second | A (square of the baseline), B (third of the baseline), C |
| order: | (baseline) |
| Type Level F1 | Minimize the sum of the intervals second order values |

Our system will find the optimal solution(s) of this problem and these constraints

1. We claim an original method based on a combination of logical and numerical constraints, such as presented in this application, that can be at the same time very specific and very general, to mathematically model real life problems of complex sequencing optimization, in combining logical and numerical, and in providing the user of our method a simple methodology and a simple approach (with for example a user interface with preselected choices) to describe complex problems of tasks sequencing optimization.
